(19) United States
(12) Patent Application Publication
(10) Pub. No.: US 2016/0296080 A1
(43) Pub. Date: Oct. 13, 2016

(54) Dispenser with Level Sensor

(71) Applicant: HYGIENE VISION EUROPE BVBA, Hoeselt (BE)

(72) Inventor: Carlo Mark Jozef Jeunen, Hoeselt (BE)

(21) Appl. No.: 15/034,156

(22) PCT Filed: Nov. 14, 2014
(86) PCT No.: PCT/EP2014/074589

§ 371 Date: May 3, 2016

(30) Foreign Application Priority Data
Nov. 15, 2013 (EP) 13193166.9

(51) Int. Cl. A47K 5/12; B05B 12/00; B05B 12/08; B05B 11/00

(52) U.S. Cl. CPC A47K 5/1202; B05B 11/0054; B05B 12/004; B05B 12/081

(57) ABSTRACT

Dispenser (1) for dispensing a fluid, the dispenser (1) comprising a frame (5), the frame (5) enclosing a dispensing mechanism (2) and a reservoir (3), and the frame (5) being provided to enclose a refill (4), the dispensing mechanism (2) being adapted for emitting discrete charges of said fluid via an outlet (8) to an exterior of said frame (5), the dispensing mechanism (2) being in fluid connection with the reservoir (3), the reservoir comprising connection means (10) for fluid connection with the refill (4), a sensor (12) being provided in the reservoir (3) for detecting an empty state of a refill (4) connected to the reservoir (3), the dispenser (1) further comprising notification means (15) operationally connected to said sensor (12) for notifying said empty state, wherein the sensor (12) is an electric resistance sensor mounted in an upper section of said reservoir (3).

The present invention relates to a dispenser for dispensing a fluid, wherein the dispenser comprises a frame that encloses a dispensing mechanism, and wherein the frame is further provided to enclose a refill, wherein the dispensing mechanism is adapted for emitting discrete charges of the fluid via an outlet to an exterior of the frame, and wherein connecting means are provided for fluid connection with the refill.

Such dispensers are known and are frequently used for example for dispensing liquid soap in public toilets. Another example of such a dispenser is an air purifier which emits a charge of perfumed air at regular periods of time. The invention thereby particularly relates to such dispensers that are provided with a refill that is replaceably mounted in the dispenser, and which provides the fluid to the dispensing mechanism.

A drawback of known dispensers is that there is only one ideal moment for replacing the refill, being the moment where the refill is empty. When the refill is not directly replaced when it is empty, users (with an intention to use the dispenser after it is empty and before the refill is replaced) will be confronted with an empty dispenser, and the needs of the used cannot be satisfied. To avoid this, the refill is in practice typically replaced during a maintenance before it is empty. As a result, some fluid from the refill will not be used and is wasted.

EP 0 663 175 discloses a dispenser for dispensing a fluid, wherein a reservoir is provided between the refill and the dispensing mechanism. Thereby, the reservoir serves as a buffer mechanism, so that when the refill is empty, the dispensing mechanism still has a predetermined amount of discrete charges of fluid available in the reservoir. This creates a longer period of time wherein the refill can be replaced without the dispenser running empty. Therefore the user can be satisfied while fluid from the refill should not be wasted and can be completely used.

A drawback of the known dispenser is that the costs for manufacturing and maintenance such reservoir and dispensing mechanism is high.

It is an object of the present invention to provide a dispenser that is less expensive in production and in maintenance, and wherein the dispensing mechanism can emit a predetermined amount of discrete charges of the fluid, when the refill is empty.

To this end, the invention provides a dispenser for dispensing a fluid, the dispenser comprising a frame, the frame enclosing a dispensing mechanism and a reservoir, and the frame is provided to enclose a refill, the dispensing mechanism being adapted for emitting discrete charges of the fluid via an outlet to an exterior of the frame, the dispensing mechanism is in fluid connection with a reservoir, the reservoir comprising connection means for fluid connection with the refill, characterized in that a sensor is provided in the reservoir for detecting an empty state of a refill connected to the reservoir, the dispenser further comprising notification means operationally connected to said sensor for notifying said empty state, wherein the sensor is an electric resistance sensor mounted in an upper section of said reservoir.

In the dispenser of the invention, a sensor is provided in the reservoir for detecting an empty state of a refill, connected to the reservoir, the dispenser further comprising notification means operationally connected to the sensor for notifying the empty state. Due to the presence of the sensor, operationally connected to the notification means, the optimal moment for replacing the refill can be sensed by the sensor and notified to an operator. Thereby, during maintenance, the frame of the dispenser should not be opened to visually check whether the refill is to be replaced. The empty state of the refill is notified by the notification means. This facilitates maintenance of the dispenser.

Furthermore, the sensor is an electric resistance sensor. An electric resistance sensor is a cheap sensor that can be easily integrated in the dispenser. Thereby, the electric resistance sensor measures a low resistance when fluid is present, and measures a high resistance when fluid is not present (when air is present). This shows that an electric resistance sensor provides in a simple technical solution to measure the presence of a fluid.

Furthermore, the sensor is mounted in an upper section of the reservoir, more preferably, the sensor is mounted at the location of the connection means. By placing the sensor in an upper section of the reservoir, preferably at the top of the reservoir, where the refill is connected to the reservoir, an empty state of the refill can be detected at a moment where the reservoir is still full or substantially full.

The specific choice of features of the sensor that is placed in the dispenser of the invention allows to communicate in an efficient manner based on a sensor measurement, to an operator of the dispenser that the refill is to be changed, and wherein the sensor is cheap. In this manner, the invention provides in a dispenser that is less expensive in production and in maintenance, and wherein the dispensing mechanism can emit a predetermined amount of discrete charges of the fluid, when the refill is empty.

Preferably, the dispenser according to the invention has a three-fold structure. The three-fold structure comprises three elements or modules cooperating together. The first element is the frame of the dispenser. The second element is the second frame that interconnects the dispensing mechanism and the reservoir. This second frame is removably mounted in the frame (and is thus removably mounted with respect to the first element of the three-fold structure). The third element is the refill. The refill is replaceably connected to the connection means of the reservoir (being the second element in the three-fold structure).

This feature is based on the insight that different elements in the dispenser have different ideal lifetimes. It will be clear that the refill has the shortest lifetime (the lifetime of the refill being defined by the purpose of the refill, which is providing the dispenser with a predetermined amount of fluid). The frame of the dispenser typically has a long lifetime and remains unchanged for the complete period of existence of the dispenser. This frame is typically mounted at a fixed position, for example against a wall, and the frame is not intended to be removed from its fixed position.

In many prior art dispensers without reservoirs, the dispensing mechanism and refill are combined into one single element. Thus, when the refill is replaced, the dispensing mechanism is also replaced. This provides the advantage that a new dispensing mechanism is regularly provided, thereby preventing failure of the dispensing mechanism. In the dispenser according to the prior art with the reservoir, the dispensing mechanism is integrally formed with the frame of the dispenser. Therefore, the dispensing mechanism is built to last for the complete lifetime of the dispenser. Such dispensing mechanisms are expensive in production and in maintenance of the dispenser.

According to this preferred embodiment of the invention, the reservoir and dispensing mechanism, interconnected via the second frame, form a second element of the three-fold structure. This second element is removably mounted in the frame of the dispenser (the first element). Thereby, the dispensing mechanism is replaceable, and should not be constructed to last for the complete lifetime of the dispenser. This allows the dispensing mechanism to be produced significantly cheaper. Furthermore, since the dispensing mechanism and reservoir are not formed as a single piece together with the refill, the dispensing mechanism can have a lifetime that is longer than the lifetime of the refill. Thereby, one dispensing mechanism and reservoir can be used to emit a fluid from multiple refills.

The above shows how the three-fold structure allows to optimize the production and maintenance cost of each of the elements in the structure. The frame of the dispenser can have a solid and firm structure made from a durable material to last for a long period of time (the complete lifetime of the dispenser). The refill can be produced in a cheap manner (without dispensing mechanism) to last for only a short period of time (until the refill is empty). The dispensing mechanism and reservoir can be produced with an optimized durability in function of their production costs, so that the dispensing mechanism and reservoir can be replaced after a predetermined period of time that is somewhere in between the short period of time (refill) and the long period of time (frame). Thereby, the dispensing mechanism and reservoir are replaceable after a predetermined amount of emitted charges, or after having emptied a predetermined amount of refills.

This three-fold structure thereby provides in a further advantageous solution to significantly reduce the production costs, and the maintenance costs of a fluid dispenser with a reservoir.

Preferably, the reservoir has a minimum capacity of 0.02 liter, more preferably 0.05 liter, most preferably 0.10 liter. Tests have shown that providing the reservoir with such a minimum capacity creates a sufficient buffer for the dispenser to continue operating after the refill is empty. Alternatively, the reservoir capacity can be defined in function of the number of discrete charges, whereby the reservoir preferably comprises at least 100 discrete charges of fluid.

Preferably, the second frame is mounted in the frame via a snap-fit connection. A snap-fit connection allows to easily mount and replace a dispensing mechanism and reservoir via the second frame. Thereby, maintenance costs are minimized.

Preferably, when a refill is connected to the reservoir, the refill, reservoir and dispensing mechanism form a closed dispensing system wherein fluid from the refill provides fluid to the reservoir, which reservoir provides fluid to the dispensing mechanism. A closed dispensing system is defined as a dispensing system having no opening to the exterior environment. As a result, air cannot enter the closed system. Refills are typically provided in bags that shrivel during emptying, so that no incoming air is needed to replace ejected charges of fluid. Furthermore, a refill typically comprises a predetermined amount of air inside the refill. This air (which is typically purified and therefore clean air) can enter the reservoir when the refill is empty, so that the reservoir can operate as a buffer when the refill is empty. Using such a closed system, contaminations are prevented from entering the dispensing system and polluting the fluid that is emitted to the user. Open dispensing systems often suffer from such pollution, which is time consuming to remove from the dispenser. As a result, via the closed system, maintenance time, and thus maintenance costs are minimized.

Preferably, the notification means is formed as a visual indicator such as a LED. Providing a visual indicator is technically easy and cheap, and provides a clear notification. Alternatively, communication systems are integrated into the notification means so that an empty state of the refill can be communicated to an external server so that maintenance can be scheduled.

The invention is particularly related to liquid soap dispensers where the fluid is a liquid soap. The invention further relates to a dispenser frame (first element of the three-fold structure of the dispenser) from the dispenser. The invention further relates to the dispensing mechanism and reservoir interconnected via the second frame (being the second element of the three-fold structure).

The invention further relates to a method for maintaining a dispenser according to the invention, wherein:
a refill is replaced in the dispenser at a first frequency; and
a dispensing mechanism and reservoir is replaced in the dispenser at a second frequency that is lower than the first frequency,
   wherein a sensor is provided in the reservoir for detecting an empty state of a refill connected to the reservoir, the dispenser further comprising notification means operationally connected to said sensor for notifying said empty state, wherein the sensor is an electric resistance sensor mounted in an upper section of said reservoir, and wherein the first frequency is determined based on said notifying said empty state by said notification means.

As is explained above in relation to the dispenser according to the invention, the three-fold structure of the dispenser allows to replace the refill at another frequency than the dispensing mechanism and reservoir. This allows each of the elements of the dispenser to be optimized in function of their production cost and lifetime. Thereby, the refill is replaced by removing an empty refill from the dispenser and connecting a new refill to connection means provided for this purpose at the reservoir. The dispensing mechanism and reservoir are replaced by removing a dispensing mechanism and reservoir by the dispenser; and snap-fitting a further dispensing mechanism and further reservoir, interconnected via a second frame, into the frame of the dispenser.

The invention will now be described in more details with respect to the drawings illustrating some preferred embodiments of the invention. In the drawings:

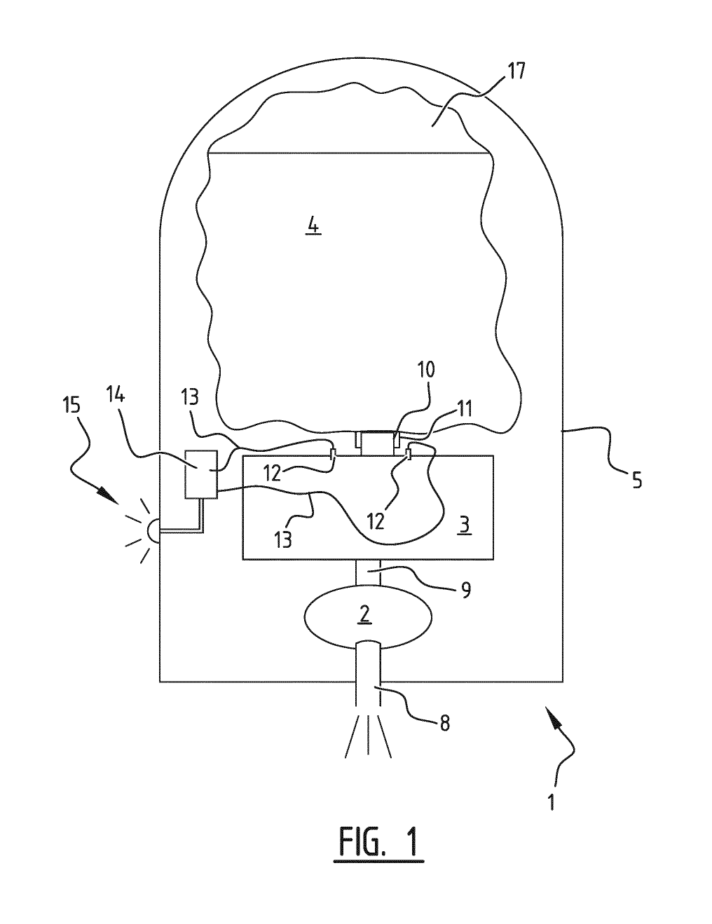

FIG. 1 shows a cross-sectional front view of a dispenser according to an embodiment of the invention; and

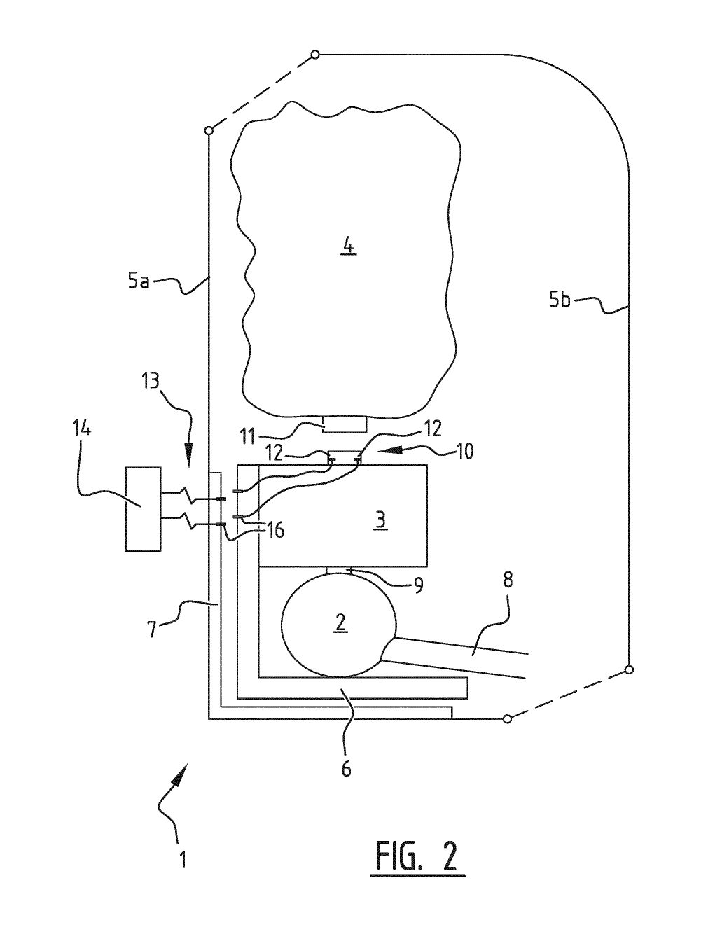

FIG. 2 shows an exploded cross-sectional side view of a dispenser according to an embodiment of the invention.

In the drawings a same reference number has been allocated to a same or analogous element.

FIG. 1 and FIG. 2 show a dispenser 1 according to an embodiment of the invention. Thereby, the shown dispenser 1 is a liquid soap dispenser. Liquid soap dispensers are often mounted in public toilets, e.g. in hotels, restaurants, and in highway facilities. Alternatively to a liquid soap dispenser, an air purifier, provided to dispense charges of perfume, can also be built according to the principles of the present invention.

The dispenser 1 comprises a dispensing mechanism 2, a reservoir 3, a refill 4 and a frame 5. Thereby, the refill 4, reservoir 3 and dispensing mechanism 2 are preferably enclosed by the frame 5 and thereby separated from an environment via the frame 5. The different elements of the dispenser 1 are interconnected to form a three-fold structure.

The dispensing mechanism 2 and reservoir 3 are interconnected via a second frame 6. The second frame 6 is formed compatible for connection with frame 5. To this end, in FIG. 2 a connection element 7 is schematically illustrated as part of the frame 5. Thereby, the second frame 6 is preferably connectable to the frame via a snap-fit connection. Thereby, snap-fit connection is defined as a mechanical joint system, where part-to-part attachment is accomplished with locating and locking means (constraint features) that are homogenous with one or the other of the components being joint. Thereby, joining is preferably obtained via flexible locking features, which move aside for engagement with the mating part, followed by return of the locking feature towards its original position to accomplish the interference required to ledge the components together. Thereby, the snap-fit connection can be formed as a click connection, or as a slide (for example dovetail) connection. Alternatively, the second frame 6 is connected to the frame 5 via screws.

The dispensing mechanism 2 is provided to emit discrete charges of fluid to an exterior of the frame 5 via an outlet 8. The outlet extends through the frame 5 between an exterior of the frame 5 and the dispensing mechanism 2. The frame 5 preferably comprises an opening through which the output 8 can extend. Preferably, the output 8 forms part of the dispensing mechanism 2, so that the dispensing mechanism 2 comprises the output 8. The dispensing mechanism 2 can be a pump (fluid to fluid), can be a spray or atomizer (liquid to small liquid particles or mist) or can be a foamer (liquid to foam). In each case, the dispensing mechanism 2 is provided with a liquid at an input side, and discrete charges of the liquid are emitted (whether or not the emitted liquid has been transformed into foam or mist).

The reservoir 3 is fluid connected between a refill 4 and the dispensing mechanism 2 so that it can function as a fluid buffer. To this end the reservoir 3 is fluid connected 9 to the dispensing mechanism 2. This fluid connection 9 is preferably formed at a lower end of the reservoir 3. At an upper end of the reservoir 3 connection means 10 are provided that are compatible with further connection means 11 of the refill 4. In this manner, a refill 4 can be connected via its further connection means 11, to the connection means 10 of the reservoir 3. Connection means for connecting refills to a dispenser are known in the art and are therefore not explained in further detail.

The refill 4 is preferably provided to shrivel when liquid is removed from the bag. An example of such a refill 4 is a 800 ml liquid soap bag. Such refill 4 is provided with a further connection means 11 that is compatible with the connection means 10 that are provided in the dispenser 1 for connecting the refill 4. Typically, in such refill 4, a predetermined amount of air 17 is present. As will be further explained, this predetermined amount of air 17 (which typically is purified air, and not contaminated) will allow the dispenser 1 as shown in FIGS. 1 and 2 to operate as a closed system.

The dispenser 1 being formed in a three-fold structure, has some advantages. Thereby, three-fold structure is defined as having three main building blocks. The first building block is the frame 5. The second building block is the combination of the dispensing mechanism 2 and the reservoir 3, which are interconnected via the second frame 6. The third building block is the refill 4. When the building blocks are interconnected to form the dispenser 1, then preferably, the refill 4, reservoir 3 and dispensing mechanism 2 form a closed system. Closed system is defined as a system without (uncontrolled) openings to the environments. It will be clear that the dispensing mechanism is provided to emit charges of the fluid to the environment via outlet 8. However, the skilled person will recognize that when the dispensing mechanism is not emitting fluid, the output 8 is closed, and thereby, the system formed by refill 4, reservoir 3 and dispensing mechanism 2 is also closed. A closed system prevents air from entering the system. Thereby, contamination of the system is prevented. In the closed system, the refill is preferably a bag that can shrivel. The air 17 that is present in the refill 4 will, when the refill 4 is empty, gradually enter the reservoir 3 during emptying of the reservoir 3 (emitting charges of the fluid via the discharging mechanism 2). This allows the reservoir 3 to be emptied without air entering the closed system. In a practical embodiment of the dispenser 1, as is shown in FIGS. 1 and 2, the closed system will only be compromised during replacement of the refill 4. During this replacement, the connection means 10 are disconnected from the further connection means 11 of the refill 4, and air can enter the closed system until a new refill 4 has been connected with its further connection means 11 to the connection means 10 of the reservoir 3. Since the exposure time during replacing of the refill 4 is limited, contamination risk is minimal.

The three-fold structure of the dispenser 1 allows to replace the different building blocks of the dispenser 1 at different frequencies. The refill 4 will typically be replaced when it is empty. Thereby, the refill 4 has a short lifetime (compared to the other building blocks). The frame 5 is typically mounted in a fixed position for the complete time of use of the dispenser 1, therefore the frame 5 has a long lifetime. To this end, the frame 5 is produced using durable materials (e.g. a plastic with stable visual properties). The second building block (dispensing mechanism 2 and reservoir 3) can be optimized in function of its lifetime and production cost. Thereby, an optimum can be found wherein the second building block has a lifetime that lays somewhere between the long lifetime of the first building block, and the short lifetime of the third building block. Preferably, the second building block is provided to empty a predetermined number N of refills 4, so that the lifetime of the second building block is N times the lifetime of the refill 4. Since the second building block is removably connected to the first building block, preferably via snap-fit connection, the second building block can be easily replaced during maintenance of the dispenser 1. Because the second building block has a lifetime that extends over the lifetime of the refill 4 (the third building block), a maintenance step (whereby a maintenance step is executed every time a refill is empty) always comprises replacement of refill 4 (thus replacement of the third building block), while once every N maintenance steps, also the second building block (reservoir 3, dispensing mechanism 2 interconnected via the second frame 6) is replaced. FIG. 2 shows these three building blocks somewhat separate from each other.

FIG. 2 shows an example of a frame 5 that provides access to the interior of the frame 5 during maintenance. To this end, the frame 5 is formed of a first frame part 5a, and a second frame part 5b. The second frame part 5b is removable from the first frame part 5a so that during maintenance, the refill 4, reservoir 3 and dispensing mechanism 2 is easily accessible.

To further facilitate that maintenance of the dispenser 1, a sensor 12 is provided to detect an empty state of the refill 4. The skilled person will recognized that different types of sensors can be used to detect such empty state 4. In the figures, an electric resistance sensor 12 (having two electrodes) is provided at an upper end of the reservoir 3. When the refill 4 contains fluid, the fluid extends between the electrodes 12 of the sensor, so that the electrical resistance between these electrodes is low (since fluid is a good conductor). When the refill 4 runs empty, and the air 17 enters the reservoir 3, this air will extend between the electrodes of the sensor 12. Therefore, a substantially high electrical resistance is measured between the electrodes 12 (since air is an electrical isolator). The electrodes 12 are connected via conductive wires 13 to an electronic circuit 14. In the electronic circuit 14, it is determined whether the electrical resistance is low or high. To this end, a threshold can be predetermined in the electrical circuit such that when the resistance falls below the threshold, the resistance is considered low (refill 4 is not empty; contains at least some fluid), whereas when the resistance is above the threshold, the resistance is considered high (the refill 4 is empty). The electronic circuit 14 is preferably adapted to initially activate the notification system only after the sensor has detected a low electrical resistance. As a result, mounting a refill in the electronic circuit will initiate the notification system, after which the electronic circuit operates as described. This further results in that after production and before first use, the notification system is inactive.

The electronic circuit 14 is connected to notification means. In FIG. 1, the notification means is a visual indicator, for example a LED 15. The skilled person will recognize that there are different ways to notify an empty refill 4 via a visual indicator. In a first example, the visual indicator lights up (for example gives a green light) when the refill 4 is full (or at least partially full). In another example, the visual indicator lights up (for example a red light) when the refill 4 is empty. The skilled person will recognize that combinations of the above, or variations (using for example blinking lights) can be designed to serve the same purpose without departing from the scope of the invention.

The notification means can alternatively be formed as communication means that communicates with an external server. This server can be accessed by a maintenance operator, which is notified via the server that a dispenser 1 is empty (or at least the refill 4 is empty, while the dispenser 1 still contains fluid in the reservoir 3), so that a maintenance can be scheduled. Further alternatively, the notification means are adapted for also notifying that the dispensing mechanism and reservoir are to be replaced. The notification means are therefore preferably provided for outputting two distinct visual signals, a first for indicating that the refill is to be replaced and a second for indicating that the dispensing mechanism and reservoir is to be replaced. The notification that the dispensing mechanism and reservoir are to be replaced can for example be executed after a predetermined period of time, for example 2 years, from initialization or from replacement of dispensing mechanism and reservoir. Further alternatively, the notification means are further adapted to notify that a battery connected to the electronic circuit is to be replaced.

FIG. 1 shows the sensor 12 being placed in an upper region (at the top wall) of the reservoir 3. FIG. 2 shows an alternative configuration wherein the sensor 12 is placed at the connection means 10. FIG. 2 further shows how the electrical connection 13 is integrated into the second frame 6 and extends further into the frame 5 of the dispenser 1. This allows the reservoir 3 to be replaced without the necessity of replacing the electronic circuit 14. In FIG. 2, the electronic circuit 14 is shown at the outside of the frame 5, however the skilled person will recognize that the electrical connection 13 can be guided inside the frame 5, and wherein the electronic circuit 14 is placed inside the frame 5. FIG. 2 shows the electronic circuit 14 outside the frame 5 merely for clarity purposes. The sensor part that is integrated in the reservoir 3 is formed by two electrodes 12, two electric connectors 16 (that are compatible with electric connectors at frame 5), and electric wires connecting the electrodes 12 with the connector elements 16. These elements can be produced fairly cheap, and thereby do not add much to the cost of the replaceable refill 3.

An alternative of the sensor to measure whether the refill 4 is empty, is a counter that counts the number of emitted charges. Thereby, the counter can be connected to an electronic circuit 14 that notifies a user when the counter exceeds a predetermined threshold. In such alternative configuration of the sensor, or in another alternative configuration of the sensor, the complete sensing system (sensor+electronic circuit+notification means) can be provided at the frame 5 (and not at the reservoir 3). The skilled person will recognize that integrating a sensor for measuring the ideal moment for replacing the refill (by detecting whether the refill is empty as described above) is also possible in a dispenser without the threefold structure. Particularly a dispenser, where the frame 5, the dispensing mechanism 2 and the reservoir 3 are integrated into a single building block, can be provided with a sensor as described above. Via such sensor, the ideal moment for replacing the refill 4 can be easily detected.

The above described embodiments and the shown figures are illustrative and serve only for a better understanding of the invention. The invention is not limited to the described embodiments. Different alternatives, and preferred features described in the text can be freely combined by a skilled person and developed in more detail to form an operational whole without departing from the essence of the invention. The scope of protection of the invention will therefore be defined solely by the claims.

1. A dispenser for dispensing a fluid, the dispenser comprising a frame, the frame enclosing a dispensing mechanism and a reservoir, and the frame is provided to enclose a refill, the dispensing mechanism being adapted for emitting discrete charges of said fluid via an outlet to an exterior of said frame, the dispensing mechanism is in fluid connection with a reservoir, the reservoir comprising connection means for fluid connection with the refill, characterized in that a sensor is provided in the reservoir for detecting an empty state of a refill connected to the reservoir, the dispenser further comprising notification means operationally connected to said sensor for notifying said empty state, wherein the sensor is an electric resistance sensor mounted in an upper section of said reservoir.

2. The dispenser according to claim 1, wherein the electric resistance sensor comprises two electrodes mounted at a distance from one another.

3. The dispenser according to claim 1, wherein the electric resistance sensor further comprises an electronic circuit and wherein the notification means are adapted to notify the empty state when the resistance increases above a predetermined threshold.

4. The dispenser according to claim 1, wherein the reservoir has a minimum capacity of 0.02 liter, preferably 0.05 liter, more preferably 0.10 liter.

5. The dispenser according to claim 1, wherein the dispensing mechanism and the reservoir are interconnected via a second frame, which second frame is removeably mounted in said frame.

6. The dispenser according to claim 5, wherein the second frame is mounted in said frame via a snap-fit connection.

7. The dispenser according to claim 1, wherein, when a refill is connected to the reservoir, the refill, reservoir and dispensing mechanism form a closed dispensing system wherein fluid from the refill provides fluid to the reservoir, which reservoir provides fluid to the dispensing mechanism.

8. The dispenser according to claim 1, wherein the sensor is mounted at the location of said connection means.

9. The dispenser according to claim 1, wherein said notification means is formed as a visual indicator such as a LED.

10. The dispenser according to claim 1, wherein the fluid is a liquid soap.

11. A dispensing mechanism and reservoir from the dispenser according to claim 1, wherein a sensor is provided in the reservoir for detecting an empty state of a refill connected to the reservoir, the dispenser further comprising notification means operationally connected to said sensor for notifying said empty state, wherein the sensor is an electric resistance sensor mounted in an upper section of said reservoir.

12. A method for maintaining a dispenser according to claim 1, wherein:
a refill is replaced in said dispenser at a first frequency; and
a dispensing mechanism and reservoir is replaced in said dispenser at a second frequency that is lower than said first frequency,
wherein a sensor is provided in the reservoir for detecting an empty state of a refill connected to the reservoir, the dispenser further comprising notification means operationally connected to said sensor for notifying said empty state, wherein the sensor is an electric resistance sensor mounted in an upper section of said reservoir, and wherein the first frequency is determined based on said notifying said empty state by said notification means.

13. The method according to claim 12, wherein the refill is replaced by:
removing an empty refill from the dispenser; and
connecting a new refill with connection means of the reservoir.

14. The method according to claim 12, wherein the dispensing mechanism and reservoir is replaced by:
removing a dispensing mechanism and reservoir from the dispenser; and
snap-fitting a further dispensing mechanism and further reservoir, interconnected via a second frame, in the frame of the dispenser.
